(19) United States
(12) Patent Application Publication
(10) Pub. No.: US 2026/0369000 A1
(43) Pub. Date: Nov. 19, 2026

(54) IMAGE GENERATION DEVICE, IMAGE GENERATION METHOD, AND IMAGE GENERATION PROGRAM

(71) Applicant: Sony Interactive Entertainment Inc., Tokyo (JP)

(72) Inventors: Takakazu Ikeda, Tokyo (JP); Takeshi Nakagawa, Tokyo (JP); Takashi Amada, Tokyo (JP); Kazuki Nakamura, Tokyo (JP)

(73) Assignee: Sony Interactive Entertainment Inc., Tokyo (JP)

(21) Appl. No.: 19/143,847

(22) PCT Filed: Dec. 19, 2023
(86) PCT No.: PCT/JP2023/045397

§ 371 Date: Jun. 26, 2025

(30) Foreign Application Priority Data
Jan. 10, 2023 (JP) 2023-001646

(51) Int. Cl. G06T 15/20; A63F 13/25; G06F 3/03

(52) U.S. Cl. CPC G06T 15/20; A63F 13/25; G06F 3/03

(57) ABSTRACT

An image generating device 200 according to the present invention includes a reference determining section 202 that, based on a command input different from a command input regarding at least one of a position and a direction of a head mounted display 100, determines at least one of a reference position and a reference direction being a position and a direction in which a user is arranged in a virtual space, a viewpoint determining section 203 that, based on at least one of the reference position and the reference direction, determines at least one of a viewpoint position and a viewpoint direction of the user in the virtual space, a rendering section 204 that generates a three-dimensional image by rendering an object of the virtual space, based on at least one of the viewpoint position and the viewpoint direction, and a re-projection section 205b that performs a re-projection process to alter the three-dimensional image such that the three-dimensional image matches at least one of a new reference position and a new reference direction.

### TECHNICAL FIELD

The present invention relates to an image generation technology.

### BACKGROUND ART

Game play is performed with a head mounted display connected to a game machine and mounted on a head part and by operation of a controller or the like while a screen displayed on the head mounted display is being watched. Once wearing a head mounted display, a user looks at nothing but an image displayed on the head mounted display. Thus, a sense of immersion into an image world is increased, and an effect of further increasing entertainability of a game is obtained. In addition, when a virtual reality (VR) image is displayed on the head mounted display and the user wearing the head mounted display turns his/her head, a 360-degree omnidirectional virtual space that provides a 360-degree visual field is displayed. As a result, the sense of immersion into an image world can be further increased, and operability of an application of a game or the like is also increased.

In a case where, with a head mounted display having such a head tracking function, a VR image is generated with a viewpoint position and a viewpoint direction being changed in conjunction with the position and direction of a user's head, a delay is generated between generation and displaying of the VR image. Thus, there may be generated a difference between the position and direction of the user's head that are the basis for the image generation and the position and direction of the user's head corresponding to the display timing of the VR image on the head mounted display. As a result, the user may feel dizzy (referred to as VR sickness). In light of such circumstances, a re-projection process has typically been used to correct a rendered image to be suited for the head mounted display position and direction corresponding to the display timing of the image.

### SUMMARY

### Technical Problem

A viewpoint position and a viewpoint direction of a user in a virtual space change according to the position and the direction of a head mounted display and also according to a position and a direction in which the user is arranged in a virtual space. In some cases, the position and the direction in which the user is arranged change in a time period between one image generation time point and the next image creation time point. In this case, the position and direction in which the user is arranged and that have been changed in such a time period are not reflected, and a three-dimensional image differs from the user's expectation, causing the user to have a feeling of strangeness in some cases.

In view of the abovementioned circumstances, an object of the present invention is to provide a technology of preventing a user from having a feeling of strangeness for a three-dimensional image due to misarrangement of the user in a virtual space.

### Solution to Problem

In order to solve the above problem, an image generating device according to a certain aspect of the present invention includes a reference determining section that, based on a command input different from a command input regarding at least one of a position and a direction of a head mounted display, determines at least one of a reference position and a reference direction being a position and a direction in which a user is arranged in a virtual space, a viewpoint determining section that, based on at least one of the reference position and the reference direction, determines at least one of a viewpoint position and a viewpoint direction of the user in the virtual space, a rendering section that generates a three-dimensional image by rendering an object of the virtual space, based on at least one of the viewpoint position and the viewpoint direction, and a re-projection section that performs a re-projection process to alter the three-dimensional image such that the three-dimensional image matches at least one of a new reference position and a new reference direction.

An image generating method according to another aspect of the present invention includes a step of, based on a command input different from a command input regarding at least one of a position and a direction of a head mounted display, determining at least one of a reference position and a reference direction of a user in a virtual space, a step of, based on at least one of the reference position and the reference direction, determining at least one of a viewpoint position and a viewpoint direction of the user in the virtual space, a step of generating a three-dimensional image by rendering an object of the virtual space, based on at least one of the viewpoint position and the viewpoint direction, and a step of performing a re-projection process to alter the three-dimensional image such that the three-dimensional image matches at least one of a new reference position and a new reference direction.

An image generating program according to still another aspect of the present invention, causes a computer to execute a step of, based on a command input different from a command input regarding at least one of a position and a direction of a head mounted display, determining at least one of a reference position and a reference direction of a user in a virtual space, a step of, based on at least one of the reference position and the reference direction, determining at least one of a viewpoint position and a viewpoint direction of the user in the virtual space, a step of generating a three-dimensional image by rendering an object of the virtual space, based on at least one of the viewpoint position and the viewpoint direction, and a step of performing a re-projection process to alter the three-dimensional image such that the three-dimensional image matches at least one of a new reference position and a new reference direction.

It is to be noted that a method, a device, a program, a transitory or non-transitory recording medium having a program recorded therein, or a system that is obtained by translating any combination of the above constituent elements or an expression in the present invention is also effective as an aspect of the present invention.

### Advantage Effects of Invention

The present invention can provide a technology of preventing a user from having a feeling of strangeness for a three-dimensional image due to misarrangement of the user in a virtual space.

### BRIEF DESCRIPTION OF DRAWINGS

FIG. 1 is a diagram of an appearance of a head mounted display.

FIG. 2 is a configuration diagram of an image generating system.

FIG. 3 is a configuration diagram of an image generating device in FIG. 2.

FIG. 4 is a diagram for explaining a relation among a reference position and a reference direction, an HMD position and an HMD direction, and a viewpoint position and a viewpoint direction.

FIG. 5 is a flowchart of a process flow regarding image generation in the image generating device according to a first embodiment.

FIG. 6 is a diagram for illustrating the relation among an amount of change of a reference position and a reference direction, an amount of change of an HMD position and an HMD direction, and an amount of change of a new viewpoint position and a new viewpoint direction.

FIG. 7 is a diagram for illustrating a flow of a re-projection process according to the first embodiment.

FIG. 8 is a flowchart of a process flow regarding image generation in the image generating device according to a second embodiment.

FIG. 9 is a diagram for illustrating a flow of a re-projection process according to the second embodiment.

### DESCRIPTION OF EMBODIMENTS

### First Embodiment

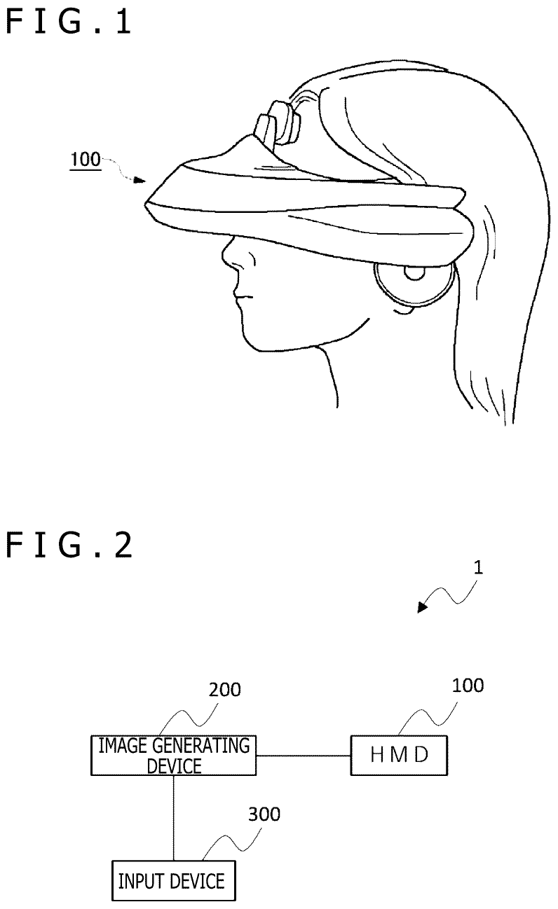

FIG. 1 is a diagram of an appearance of a head mounted display (HMD) 100. The HMD 100 is a display device for allowing a user to watch still images and videos displayed on the display and listen to sounds and music outputted from headphones when mounted on the user's head.

A gyro sensor and an acceleration sensor which are internally or externally provided to the HMD 100, for example, are used to measure the position of the head part of a user wearing the HMD 100 and the direction such as a turning angle or an inclination of the head part. In the HMD 100, the position and the direction of the head part are detected with reference to the position and the direction of the head part at a power-ON time point of the HMD 100, for example. The HMD 100 may further include a camera that photographs the user's eyes. With the camera included in the HMD 100, the gazing direction, motion of pupils, eye blinks, etc., of the user can be detected.

FIG. 2 is a configuration diagram of an image generating system according to the present embodiment. An image generating system 1 includes the HMD 100, an image generating device 200, and an input device 300.

The image generating device 200 of the present embodiment is a game machine. The image generating device 200 may be connected to a server over a network. In this case, the server may offer an on-line application, such as a game in which a plurality of users can participate over the network, to the image generating device 200.

The image generating device 200 basically processes a content program, generates three-dimensional images, and transmits the three-dimensional images to the HMD 100. The content program and data therefor are read out through a media drive (not depicted) from a read only memory (ROM) medium (not depicted) having recorded therein application software and license information of content such as a game, for example. The ROM medium is a read-only recording medium such as an optical disk, a magneto-optical disk, or a Blu-ray (registered trademark) disc. In a certain aspect, the image generating device 200 determines a viewpoint position and a viewpoint direction based on the position and the direction (hereinafter, an HMD position and an HMD direction) of the head part of a user wearing the HMD 100 and a reference position and a reference direction that are described later, creates three-dimensional images of the content at a predetermined rate such that the three-dimensional images have a view field corresponding to the determined position and direction, and transmits the three-dimensional images to the HMD 100.

The HMD 100 receives and displays the three-dimensional images generated by the image generating device 200. Three-dimensional images that are displayed on the HMD 100 may include an image photographed beforehand by the camera, a computer graphics image such as a game image, and a live image of a remote place distributed via the network. In addition, the three-dimensional images that are displayed on the HMD 100 may include a VR image, an augmented reality (AR) image, and a mixed reality (MR) image.

The input device 300 supplies various inputs received from the user to the image generating device 200. By way of example, the input device 300 supplies a command input for changing the position and direction of the user in the virtual space to the image generating device 200. The input device 300 is implemented by any one of common input devices including a game controller, a keyboard, a mouse, a joy stick, a video camera for obtaining user gestures, and a touch pad provided on a display screen of a flat display, or by a combination of them. The input device 300 of the present embodiment is one example of a user input device.

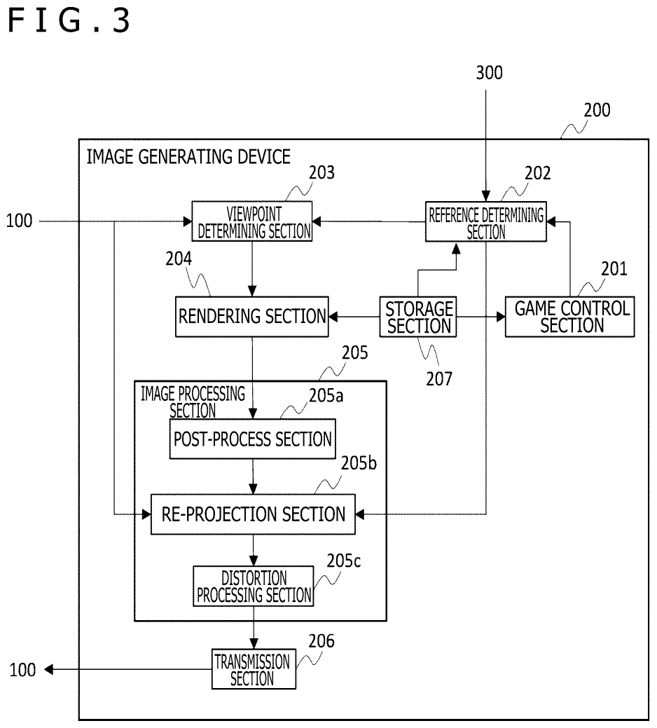

FIG. 3 is a functional configuration diagram of the image generating device 200 in FIG. 2. FIG. 3 is a block diagram focusing on the functions. These functional blocks can be implemented in many different ways by hardware only, by software only, or a combination of the two. At least some of the functions of the image generating device 200 may be implemented in the HMD 100. Alternatively, at least some of the functions of the image generating device 200 may be implemented in a server that is connected to the image generating device 200 via a network. The image generating device 200 includes a game control section 201, a reference determining section 202, a viewpoint determining section 203, a rendering section 204, an image processing section 205, a transmission section 206, and a storage section 207.

The game control section 201 advances a game by executing a game program read from the storage section 207. The game control section 201 transmits a command input for advancing a predetermined scene in a virtual space to the reference determining section 202 to change a reference position and a reference direction, each of which is to be described later, of the user in the virtual space. A “predetermined scene in a virtual space” refers to, for example, a scene indicating an effect of an object on the user in the virtual space, an event scene that occurs in the virtual space, etc. An “effect of an object on the user in the virtual space” refers to, for example, an effect of moving the user to a predetermined direction according to the positional relation between the user and the object in the virtual space, such as an effect of causing the user to collide against the object which is an item or of causing the user to be pushed or pulled by the object which is an enemy character, or an effect of moving the user along a predetermined advance route of a vehicle, such as an effect of causing the user to ride on the object which is a vehicle. An “event scene that occurs in the virtual space” refers to a scene such as a movie scene in which the user is forcibly moved in a predetermined pattern, or the like.

The reference determining section 202 determines a reference position and a reference direction being a position and a direction in which the user is arranged in the virtual space, based on a command input that is different from a command input regarding the position and the direction of the HMD 100 (hereinafter, an HMD position and an HMD direction). The reference position and the reference direction change irrespective of the change in the HMD position and the HMD direction. By way of example, the reference position and the reference direction change based on at least one of a command input provided through the input device 300 and a command input sent from the game control section 201 in order to advance a predetermined scene in the virtual space. For example, the reference position is set to a center portion of the user's body (e.g., the center portion of the trunk) in the virtual space, and the reference direction is set to the direction of the user's body (e.g., the direction of the trunk) in the virtual space. It is to be noted that the reference position that is set to a center portion of the user's body is merely an example, and the reference position may be set to any position that is at least based on the user position.

By way of example, the reference determining section 202 reads the reference position and the reference direction in the virtual space from the storage section 207, and determines a reference position and a reference direction based on a command input received from at least one of the input device 300 and the game control section 201. By using the determined reference position and reference direction, the reference determining section 202 updates the reference position and the reference direction in the storage section 207.

The viewpoint determining section 203 acquires the HMD position, the HMD direction, the reference position, and the reference direction, and determines a viewpoint position and a viewpoint direction of the user in the virtual space based on the acquired positions and directions. By way of example, with reference to the reference position and the reference direction, the viewpoint determining section 203 determines the viewpoint position and the viewpoint direction in such a manner as to reflect a relative position and a relative direction of the HMD 100 with respect to the reference position and the reference direction.

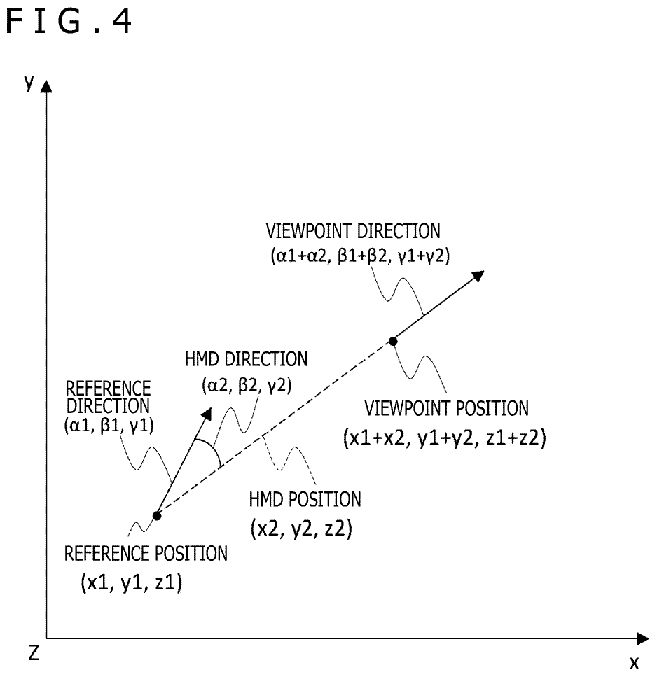

With reference to FIG. 4, an explanation will be given of the relation among the reference position and the reference direction, the HMD position and the HMD direction, and the viewpoint position and the viewpoint direction. FIG. 4 is a diagram of a three-dimensional virtual space formed of an x axis, a y axis, and a z axis which are orthogonal to each other, when viewed from the z direction. A rotation angle α about the x axis, a rotation angle β about the y axis, and a rotation angle γ about the z axis are defined. As depicted in FIG. 4, in a case where the reference position (x1, y1, z1) is determined and the HMD position (x2, y2, z2) is detected, (x1+x2, y1+y2, z1+z2) is determined as the viewpoint position. In addition, in a case where the reference direction (α1, β1, γ1) is determined and the HMD direction (α2, β2, γ2) is detected, (α1+α2, β1+β2, γ1+γ2) is determined as the viewpoint direction.

The rendering section 204 reads out image data necessary for generating an image from the storage section 207, and generates a three-dimensional image by rendering an object of the virtual space. By way of example, the rendering section 204 generates the three-dimensional image by rendering a virtual space object that can be seen in the viewpoint direction from the viewpoint position of the user wearing the HMD 100, based on the viewpoint position and the viewpoint direction of the user determined by the viewpoint determining section 203.

The image processing section 205 generates a three-dimensional image (hereinafter, referred to as an HMD image) to be displayed on the HMD 100, by performing necessary processing on the rendered image, and then gives the three-dimensional image to the transmission section 206. The image processing section 205 includes a post-process section 205a, a re-projection section 205b, and a distortion processing section 205c.

The post-process section 205a performs, on the image supplied from the rendering section 204, a post-process which is adjustment of the depth of field, tone mapping, anti-aliasing, or the like. The post-process is performed to make the three-dimensional image look natural and smooth.

The re-projection section 205b performs a re-projection process. The re-projection process includes a first re-projection process and second re-projection. The first re-projection process and the second re-projection will be explained later. The re-projection section 205b supplies the three-dimensional image having undergone the re-projection process to the distortion processing section 205c.

The distortion processing section 205c performs a process of generating an image distortion on the three-dimensional image according to a distortion generated in the optical system of the HMD 100.

The transmission section 206 transmits the HMD image generated by the image processing section 205 to the HMD 100. The transmission section 206 of the present embodiment transmits the HMD image having undergone the first re-projection process, and then, transmits the HMD image having undergone the second re-projection process. Accordingly, the transmission section 206 of the present embodiment causes the HMD 100 to display the HMD image having undergone the first re-projection process, and then, causes the HMD 100 to display the HMD image having undergone the second re-projection process. The transmission section of the present embodiment is an example of the display control section.

The storage section 207 stores reference positions, reference directions, data necessary for generation of images, and various programs for executing various processes.

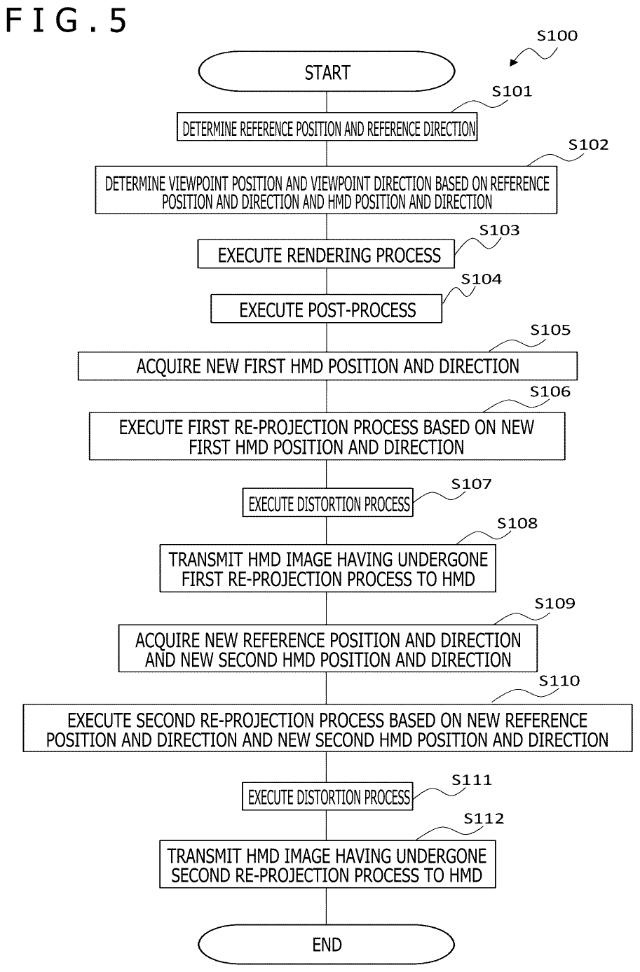

With reference to FIG. 5, a process S100 regarding image generation in the image generating device according to the present embodiment will be explained.

In step S101, the reference determining section 202 determines the reference position and the reference direction. Based on a command input received from at least one of the input device 300 and the game control section 201, the reference determining section 202 of the present embodiment determines the reference position and the reference direction such that the reference position and the reference direction are a position and a direction correspond to a timing (hereinafter, a rendering timing) of rendering the three-dimensional image.

The reference determining section 202 supplies the determined reference position and reference direction to the viewpoint determining section 203. Further, in a case where a new reference position and a new reference direction are determined, the reference determining section 202 supplies the new reference position and direction determined to the re-projection section 205b.

In step S102, the viewpoint determining section 203 sets the viewpoint position and the viewpoint direction based on the HMD position, the HMD direction, the reference position, and the reference direction. The viewpoint determining section 203 supplies the determined viewpoint position and viewpoint direction to the rendering section 204.

In step S103, the rendering section 204 generates the three-dimensional image by rendering an object of the virtual space, based on the determined viewpoint position and viewpoint direction. The rendering section 204 supplies the generated three-dimensional image to the post-process section 205a of the image processing section 205.

In step S104, the post-process section 205a performs the post-process on the rendered three-dimensional image. The post-process section 205a supplies the three-dimensional image having undergone the post-process to the re-projection section 205b.

In step S105, the re-projection section 205b acquires a new first HMD position and a new first HMD direction. The new first HMD position and the new first HMD direction here are an HMD position and an HMD direction that are obtained at the rendering timing of the three-dimensional image.

In step S106, the re-projection section 205b performs the first re-projection process on the three-dimensional image having undergone the post-process, based on the amount of change from the HMD position and the HMD direction to the new first HMD position and the new first HMD direction. The first re-projection process is a process of altering the three-dimensional image having undergone the post-process, such that the three-dimensional image matches the new HMD position and the new HMD direction, based on the new HMD position and the new HMD direction. As a result of the first re-projection process, a delay which is caused by the difference between the HMD position and the HMD direction in step S102 and the new first HMD position and the new first HMD direction obtained at the rendering timing can be reduced. The re-projection section 205b supplies the three-dimensional image having undergone the post-process and the first re-projection process to the distortion processing section 205c.

In step S107, the distortion processing section 205c performs a distortion process on the three-dimensional image having undergone the post-process and the first re-projection process. The distortion processing section 205c supplies the three-dimensional image having undergone the post-process, the first re-projection process, and the distortion process to the transmission section 206.

In step S108, the transmission section 206 transmits, as an HMD image, the three-dimensional image having undergone the post-process, the first re-projection process, and the distortion process to the HMD 100. Accordingly, the HMD image having undergone the first re-projection process is displayed on the HMD 100.

In step S109, the re-projection section 205b acquires a new reference position, a new reference direction, a new second HMD position, and a new second HMD direction. The new reference position, the new reference direction, the new second HMD position, and the new second HMD direction are, for example, a reference position, a reference direction, an HMD position, and an HMD direction corresponding to a timing that is a predetermined amount of time after the display timing of the HMD image on the HMD 100. By way of example, in a case where the rendering is performed at a frame rate of 60 frames per second (fps) and a frame interval is 16.6 milliseconds (ms), a reference position, a reference direction, an HMD position, and an HMD direction corresponding to a timing that is 8.3 ms as the predetermined amount time after the display timing of the HMD image on the HMD 100 are defined as the new reference position, the new reference direction, the new second HMD position, and the new second HMD direction. It is to be noted that the display timing of the HMD image on the HMD 100 is determined in light of, for example, an expected transmission time required to transmit an image rendered in the image generating device 200 to the HMD 100.

In step S110, the re-projection section 205b performs the second re-projection process based on the amount of change from the reference position and the reference direction to the new reference position and the new reference direction (hereinafter, referred to as the change amount of the reference position and the reference direction) and the amount of change from the HMD position and the HMD direction to the new second HMD position and the new second HMD direction (hereinafter, referred to as the change amount of the HMD position and the HMD direction). The second re-projection process is a process of altering the three-dimensional image having undergone the post-process, such that the three-dimensional image matches the new viewpoint position and the new viewpoint direction, based on the reference position, the reference direction, the new reference position, the new reference direction, the HMD position, the HMD direction, the new HMD position, and the new HMD direction. As a result of the second re-projection process, the three-dimensional image having undergone the post-process is altered to a three-dimensional image that can be seen from the new viewpoint position and the new viewpoint direction.

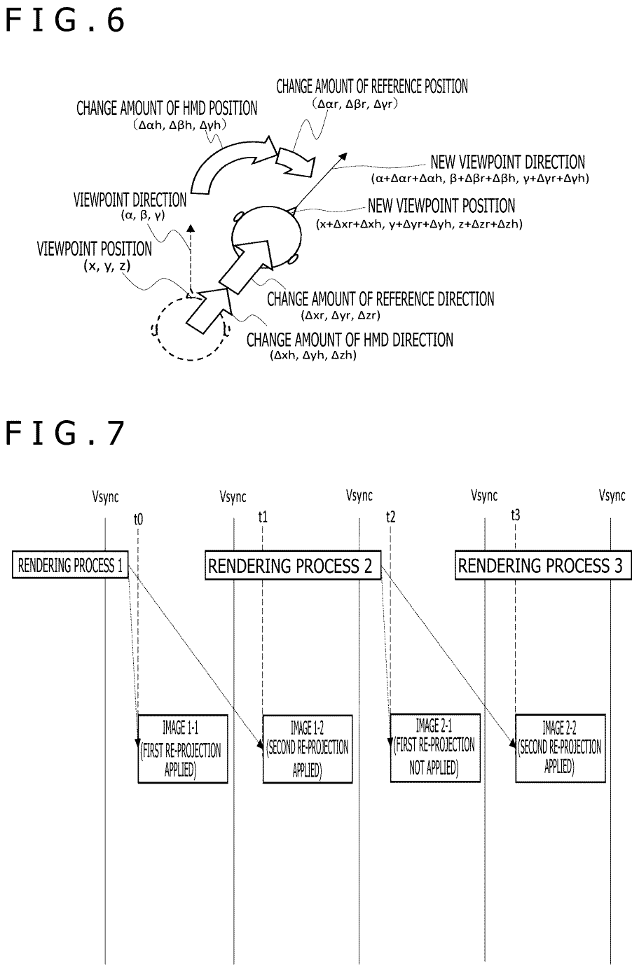

Here, with reference to FIG. 6, an explanation will be given of the relation among the amount of change of the reference position and the reference direction, the amount of change of the HMD position and the HMD direction, and the new viewpoint position and viewpoint direction. As depicted in FIG. 6, when the viewpoint position determined in step S102, the amount of change of the reference position, and the amount of change of the HMD position are (x, y, z), (Δxr, Δyr, Δzr), and (Δxh, Δyh, Δzh), respectively, the new viewpoint position can be expressed by (x+Δxr+Δxh, y+Δyr+Δyh, z+Δzr+Δzh). Also, when the viewpoint direction determined in step S102, the amount of change of the reference direction, and the amount of change of the HMD direction are (α, β, γ), (Δαr, Δβr, Δγr), and (Δαh, Δβh, Δγh), respectively, the new viewpoint direction can be expressed by (α+Δαr+Δαh, β+Δβr+Δβh, γ+Δγr+Δγh).

The re-projection section 205b makes a linear interpolation on the viewpoint position on the basis of, for example, the new viewpoint position such as that expressed above, and makes a spherical linear interpolation on the viewpoint direction on the basis of, for example, the new viewpoint direction such as that expressed above, whereby the re-projection process is performed. Accordingly, the three-dimensional image is altered in such a manner as to match the new viewpoint position and the new viewpoint direction. The re-projection section 205b supplies the three-dimensional image having undergone the second re-projection process to the distortion processing section 205c.

In step S111, the distortion processing section 205c performs the distortion process on the three-dimensional image having undergone the second re-projection process. The distortion processing section 205c supplies the three-dimensional image having undergone the post-process, the second re-projection process, and the distortion process to the transmission section 206.

In step S112, the transmission section 206 transmits, as an HMD image, the three-dimensional image having undergone the post-process, the second re-projection process, and the distortion process to the HMD 100. Accordingly, the HMD image having undergone the second re-projection process is displayed on the HMD 100.

After step S112, the process S100 is ended.

With reference to FIG. 7, the flow of the re-projection process in the first embodiment will be explained. In FIG. 7, a synchronization timing Vsync represents a vertical synchronization timing in a display panel of the HMD 100. When the rendering timing of the three-dimensional image comes, a rendering process 1 is performed based on the reference position, the reference direction, the HMD position, and the HMD direction corresponding to the rendering timing. Next, the first re-projection process based on the new first HMD position and the new first HMD direction obtained at the rendering timing of the rendering process 1 is performed on the rendered three-dimensional image, and the three-dimensional image having undergone the first re-projection process is transmitted to the HMD 100. As a result, a three-dimensional image 1-1 to which the first re-projection process has been applied is displayed on the HMD 100 at time stamp t0 (corresponding to the abovementioned steps S101 to S108). The reason why the reference position and the reference direction are not taken into consideration in the first re-projection process is that the reference position and the reference direction corresponding to the rendering timing are used for the three-dimensional image 1-1 and the reference position and the reference direction at time stamp to can thus be regarded to be roughly reflected. Next, the three-dimensional image rendered in the rendering process 1 is subjected to the second re-projection process based on the new reference position, the new reference direction, the new second HMD position, and the new second HMD direction corresponding to a timing that is a predetermined amount of time after time stamp to (e.g., a timing immediately before time stamp t1), and the three-dimensional image having undergone the second re-projection process is transmitted to the HMD 100. The predetermined amount of time here is, for example, an amount of time shorter than a frame interval time between the display timing of the three-dimensional image on the HMD 100 and the display timing of a three-dimensional image of the next frame on the HMD 100. For example, the predetermined amount of time may be set to an amount of time equivalent to a half of the frame interval time. By way of example, in a case where the frame interval time is 16.6 ms, 8.3 ms is determined as the predetermined amount of time. Thereafter, a three-dimensional image 1-2 to which the second re-projection process has been applied is displayed on the HMD 100 at time stamp t1 (corresponding to the abovementioned steps S109 to S112).

When the next rendering timing comes, a rendering process 2 is performed based on the reference position, the reference direction, the HMD position, and the HMD direction corresponding to the rendering timing. Next, on the rendered three-dimensional image, the first re-projection process is performed based on the new first HMD position and the new first HMD direction obtained at the rendering timing of the rendering process 2, and a three-dimensional image 2-1 to which the first re-projection process has been applied is displayed on the HMD 100 at time stamp t2. Next, on the three-dimensional image rendered in the rendering process 2, the second re-projection process is performed based on the new reference position, the new reference direction, the new second HMD position, and the new second HMD direction corresponding to a timing that is the predetermined amount of time after time stamp t2 (e.g., a timing immediately before time stamp t3). A three-dimensional image 2-2 to which the second re-projection process has been applied is displayed on the HMD 100 at time stamp t3.

Here, there is a case where a command input from the input device 300 or the game control section 201 is made in a time period between one image generation time point and the next image generation time point, and the reference position and the reference direction of the user in the virtual space change in this time period. If the rendering is performed at a frame rate of, for example, 60 fps, change in the reference position and the reference direction within a time period of 16.67 ms or so is not reflected in the HMD image no matter how high the speed of the central processing unit (CPU) is. As a result, the HMD image differs from the user's expectation, so that the user may have a feeling of strangeness.

In the present embodiment, the re-projection process for altering the three-dimensional image such that the three-dimensional image matches the new reference position and the new reference direction is performed. With this configuration, change in the reference position and the reference direction in a time period between one image generation time point and the next image generation time point is reflected in the HMD image. Accordingly, the user can be prevented from having a feeling of strangeness for the HMD image due to the change in the reference position and the reference direction.

In the second re-projection process of the present embodiment, the three-dimensional image is altered in such a manner as to match the new viewpoint position and the new viewpoint direction, based on the amount of change from the HMD position and the HMD direction to the new second HMD position and the new second HMD direction and the amount of change from the reference position and the reference direction to the new reference position and the new reference direction. With this configuration, the re-projection process is performed while change in the reference position and reference direction and also change in the HMD position and HMD direction are taken into consideration. Consequently, the user can be more effectively prevented from having a feeling of strangeness for the HMD image.

In the present embodiment, the transmission section 206 causes the HMD 100 to display the three-dimensional image, and then, causes the HMD 100 to display the three-dimensional image having undergone the second re-projection process, and, in the second re-projection process, the three-dimensional image is altered in such a manner as to match the new reference position and the new reference direction corresponding to a timing that is a predetermined amount of time after the display timing of the three-dimensional image. With this configuration, after the three-dimensional image is displayed, an image having been altered in such a manner as to match the new reference position and the new reference direction is interpolated, so that display at a higher frame rate can be realized.

Modifications of the embodiment will be explained below.

In the present embodiment, the viewpoint position and the viewpoint direction are determined based on the HMD position, the HMD direction, the reference position, and the reference direction, but the invention is not limited to this. The viewpoint position and the viewpoint direction may be determined based on the reference position and the reference direction. In this case, performing the re-projection process based on the new reference position and the new reference direction is sufficient.

In the present embodiment, the re-projection process is performed with regard to positions and directions. However, the re-projection process may be performed with regard to at least either positions or directions.

In the present embodiment, one three-dimensional image to which the second re-projection process has been applied is generated and displayed during a time period between the rendering timing of the three-dimensional image and the next rendering timing, as depicted in FIG. 7, but the invention is not limited to this. Two or more three-dimensional images to which the second re-projection process has been applied may be generated and displayed at different time stamps.

In the present embodiment, the HMD image having undergone the first re-projection process is transmitted, and then, the HMD image having undergone the second re-projection process is transmitted, but the invention is not limited to this. The HMD image not having undergone the re-projection process (i.e., the three-dimensional image generated by the rendering process in step S103) may be transmitted, and then, the HMD image having undergone the second re-projection process may be transmitted.

### Second Embodiment

Hereinafter, the second embodiment of the present invention will be explained. In the drawings and the explanation of the second embodiment, elements and members identical to or equivalent to those of the first embodiment are denoted by the same reference signs. An explanation that overlaps with that in the first embodiment is omitted if necessary, and the configuration different from that of the first embodiment will mainly be described.

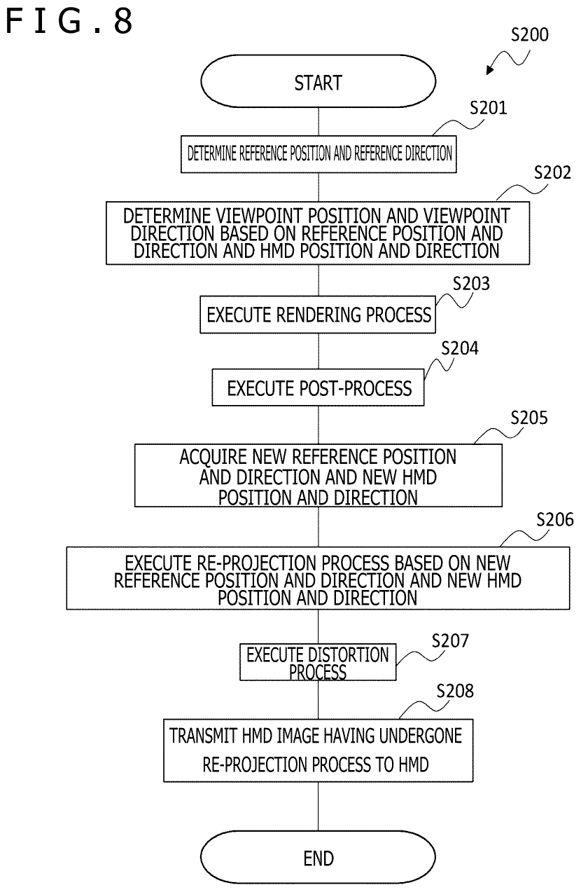

With reference to FIG. 8, an explanation will be given of a process S200 regarding image generation in the image generating device according to the present embodiment. Steps S201 to S208 are basically similar to steps S101 to S104 and S109 to S112 in FIG. 5. In other words, in the process S200 of the present embodiment, not the first re-projection process in step S108 in FIG. 5 which is based on only the new HMD position and the new HMD direction but the second re-projection process which is based on the new reference position, the new reference direction, the new HMD position, and the new HMD direction corresponding to the display timing of the three-dimensional image on the HMD 100 is performed.

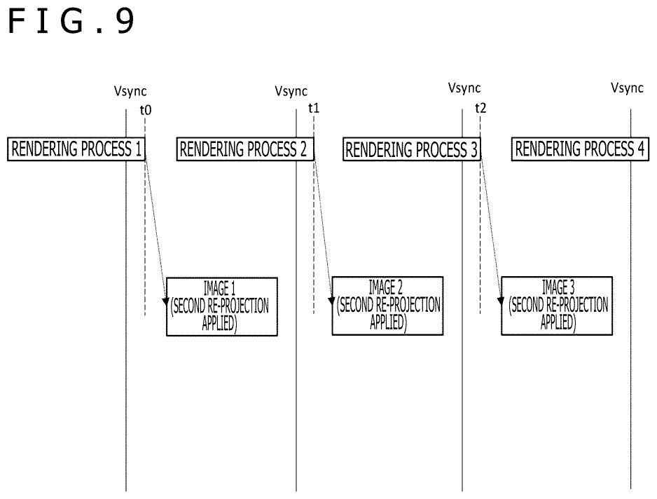

With reference to FIG. 9, the flow of the re-projection process according to the second embodiment will be explained. When the rendering timing of the three-dimensional image comes, a rendering process 1 is performed based on the reference position, the reference direction, the HMD position, and the HMD direction corresponding to the rendering timing. Next, on the three-dimensional image rendered in the rendering process 1, the second re-projection process is performed based on the new reference position, the new reference direction, the new HMD position, and the new HMD direction corresponding to the display timing of the three-dimensional image on the HMD 100, and the three-dimensional image having undergone the second re-projection process is transmitted to the HMD 100. Here, the reference position, etc., obtained at a timing (time stamp t0) of transmitting the three-dimensional image to the HMD 100 may be regarded as the “new reference position, etc., corresponding to the display timing of the three-dimensional image on the HMD 100.” Alternatively, the “new reference position, etc., corresponding to the display timing of the three-dimensional image on the HMD 100” that is estimated by a known technique on the basis of a new reference position, etc., obtained after the rendering timing may be used. Thereafter, the three-dimensional image to which the re-projection process based on the new reference position, the new reference direction, the new HMD position, and the new HMD direction corresponding to the display timing of the three-dimensional image on the HMD 100 has been applied is displayed on the HMD 100.

Here, a slight delay is generated between the generation and the displaying of the three-dimensional image. During this time period, the reference position and the reference direction can be displaced. To cope with such displacement, in the present embodiment, the re-projection process is performed to alter the three-dimensional image such that the three-dimensional image matches the new reference position and the new reference direction corresponding to the display timing of the three-dimensional image on the HMD 100. With this configuration, the user can be more effectively prevented from having a feeling of strangeness for the HMD image because the user is less likely to recognize the displacement of the reference position and the reference direction.

Also in the second embodiment, during a time period between one rendering timing of the three-dimensional image and the next rendering timing, one or more three-dimensional images to which the re-projection process has been additionally applied such that the one or more three-dimensional images match the new reference position and the new reference direction corresponding to a timing that is a predetermined amount of time after the first display timing of the three-dimensional image in the rendering process may be displayed, as in the modification of the first embodiment.

Specifically, in the embodiment of FIG. 9, the second re-projection process is performed once in one rendering process, but the second re-projection process may be performed multiple times in one rendering process.

The present invention has been explained so far on the basis of the embodiments. The embodiments exemplify the present invention, and a person skilled in the art will understand that various modifications can be made to a combination of the constituent elements or the process steps of the embodiments and that these modifications are also within the scope of the present invention. The modifications are explained.

### INDUSTRIAL APPLICABILITY

The present invention relates to an image generation technology.

### REFERENCE SIGNS LIST

100: Head mounted display
200: Image generating device
201: Game control section
202: Reference determining section
203: Viewpoint determining section
204: Rendering section
205: Image processing section
205a: Post-process section
205b: Re-projection section
205c: Distortion processing section
206: Transmission section
207: Storage section
300: Input device

1. An image generating device comprising:
a computer configured to:
based on a command input different from a command input regarding at least one of a position and a direction of a head mount display, determine at least one of a reference position and a reference direction being a position and a direction in which a user is arranged in a virtual space;
based on at least one of the reference position and the reference direction and the command input regarding at least one of the position and the direction of the head mount display (HMD), determine at least one of a viewpoint position and a viewpoint direction of the user in the virtual space;
generate a three-dimensional image by rendering an object of the virtual space based on at least one of the viewpoint position and the viewpoint direction; and
perform a re-projection process to alter the three-dimensional image such that the three-dimensional image matches at least one of a new reference position and a new reference direction, based on an amount of change from at least one of the position and the direction of the HMD to at least one of a new position and a new direction of the HMD and an amount of change from at least one of the reference position and the reference direction to at least one of the new reference position and the new reference direction.

2. (canceled)

3. The image generating device according to claim 1, comprising:
a display controller that causes the HMD to display the three-dimensional image, and then causes the HMD to display the three-dimensional image having undergone the re-projection process, wherein,
in the re-projection process, the three-dimensional image is altered in such a manner as to match at least one of the new reference position and the new reference direction corresponding to a timing that is a predetermined amount of time after a display timing of the three-dimensional image.

4. The image generating device according to claim 1, wherein,
in the re-projection process, the three-dimensional image is altered in such a manner as to match at least one of the new reference position and the new reference direction corresponding to a display timing of the three-dimensional image on the (HMD).

5. The image generating device according to claim 1, wherein
the different command input includes at least one of a command input provided via a user input device that is separate from the HMD and a command input for advancing a predetermined scene in the virtual space.

6. An image generating method comprising:
based on a command input different from a command input regarding at least one of a position and a direction of a HMD, determining at least one of a reference position and a reference direction of a user in a virtual space;
based on at least one of the reference position and the reference direction and the command input regarding at least one of the position and the direction of the HMD, determining at least one of a viewpoint position and a viewpoint direction of the user in the virtual space;
generating a three-dimensional image by rendering an object of the virtual space, based on at least one of the viewpoint position and the viewpoint direction; and
performing a re-projection process to alter the three-dimensional image such that the three-dimensional image matches at least one of a new reference position and a new reference direction, based on an amount of the change from at least one of the position and the direction of the head mount display to at least one of a new position and a new direction of the HMD and an amount of change from at least one of the reference position and the reference direction to at least one of the new reference position and the new reference direction.

7. A non-transitory computer readable medium having stored thereon an image generating program that, when executed by a computer, causes the computer to execute a method, comprising:
based on a command input different from a command input regarding at least one of a position and a direction of a HMD, determining at least one of a reference position and a reference direction of a user in a virtual space;
based on at least one of the reference position and the reference direction and the command input regarding at least one of the position and the direction of the HMD, determining at least one of a viewpoint position and a viewpoint direction of the user in the virtual space;
generating a three-dimensional image by rendering an object of the virtual space, based on at least one of the viewpoint position and the viewpoint direction; and
performing a re-projection process to alter the three-dimensional image such that the three-dimensional image matches at least one of a new reference position and a new reference direction, based on an amount of change from at least one of the position and the direction of the HMD to at least one of a new position and a new direction of the HMD and an amount of change from at least one of the reference position and the reference direction to at least one of the new reference position and the new reference direction.

8. The image generating device of claim 1, wherein the computer is further configured to generate an image distortion on the three-dimensional image according to a distortion generated in an optical system of the HMD after performing the re-projection process.

9. The image generating device of claim 1, wherein the re-projection process comprises:
a first re-projection process performed on the rendered three-dimensional image based on the new first HMD position and the new first HMD direction obtained at a rendering timing; and
a second re-projection process performed on the rendered three-dimensional image based on the new reference position, the new reference direction, the new first HMD position and the new first HMD direction corresponding to a timing that is a predetermined amount of time after the rendering timing.

10. The image generating device of claim 9, wherein the predetermined amount of time is shorter than a frame interval of the HMD.

11. The image generating method of claim 6, further comprising:
displaying the three-dimensional image by the HMD, and then displaying the three-dimensional image having undergone the re-projection process,
wherein performing the re-projection process comprises, altering the three-dimensional image to match at least one of the new reference position and the new reference direction corresponding to a timing that is a predetermined amount of time after a display timing of the three-dimensional image.

12. The image generating method of claim 6, wherein performing the re-projection process comprises altering the three-dimensional image to match at least one of the new reference position and the new reference direction corresponding to a display timing of the three-dimensional image on the HMD.

13. The image generating method of claim 6, wherein the different command input includes at least one of a command input provided via a user input device that is separate from the HMD and a command input for advancing a predetermined scene in the virtual space.

14. The image generating method of claim 6, further comprising generating an image distortion on the three-dimensional image according to a distortion generated in an optical system of the HMD after performing the re-projection process.

15. The image generating method of claim 6, wherein the re-projection process comprises:
a first re-projection process performed on the rendered three-dimensional image based on the new first HMD position and the new first HMD direction obtained at a rendering timing; and
a second re-projection process performed on the rendered three-dimensional image based on the new reference position, the new reference direction, the new first HMD position and the new first HMD direction corresponding to a timing that is a predetermined amount of time after the rendering timing.

16. The image generating device of claim 9, wherein the predetermined amount of time is shorter than a frame interval of the HMD.

17. The non-transitory computer readable medium of claim 7, the method further comprising:
displaying the three-dimensional image by the HMD, and then displaying the three-dimensional image having undergone the re-projection process,
wherein performing the re-projection process comprises, altering the three-dimensional image to match at least one of the new reference position and the new reference direction corresponding to a timing that is a predetermined amount of time after a display timing of the three-dimensional image.

18. The non-transitory computer readable medium of claim 7, wherein performing the re-projection process comprises altering the three-dimensional image to match at least one of the new reference position and the new reference direction corresponding to a display timing of the three-dimensional image on the HMD.

19. The non-transitory computer readable medium of claim 7, wherein the different command input includes at least one of a command input provided via a user input device that is separate from the HMD and a command input for advancing a predetermined scene in the virtual space.

20. The non-transitory computer readable medium of claim 7, the method further comprising generating an image distortion on the three-dimensional image according to a distortion generated in an optical system of the HMD after performing the re-projection process.

21. The non-transitory computer readable medium of claim 7, wherein the re-projection process comprises:
a first re-projection process performed on the rendered three-dimensional image based on the new first HMD position and the new first HMD direction obtained at a rendering timing; and
a second re-projection process performed on the rendered three-dimensional image based on the new reference position, the new reference direction, the new first HMD position and the new first HMD direction corresponding to a timing that is a predetermined amount of time after the rendering timing.
